(19) United States
(12) Patent Application Publication
(10) Pub. No.: US 2014/0120228 A1
(43) Pub. Date: May 1, 2014

(54) BAKEWARE INSERT

(71) Applicant: WILTON INDUSTRIES, INC., Woodridge, IL (US)

(72) Inventor: Lisa BUZZELLI, Woodridge, IL (US)

(73) Assignee: WILTON INDUSTRIES, INC., Woodridge, IL (US)

(21) Appl. No.: 14/063,810

(22) Filed: Oct. 25, 2013

Related U.S. Application Data
(60) Provisional application No. 61/718,652, filed on Oct. 25, 2012.

(51) Int. Cl. A47J 43/20

(52) U.S. Cl. CPC A47J 43/20
USPC 426/512; 99/426

(57) ABSTRACT

A bakeware insert for defining a first volume and a second volume.

### CROSS-REFERENCED APPLICATIONS

This application claims priority to U.S. Application No. 61/718,652 filed Oct. 25, 2012, herein incorporated by reference in its entirety.

### FIELD OF THE INVENTION

The present invention generally relates bakeware.

### BACKGROUND OF THE INVENTION

Various bakeware are used for creating foodstuff. Most bakeware provides a vessel, such as a cup, for containing batter or other such ingredients. The materials placed in the cup may intermix or otherwise interact in a manner not intended. The user is restricted in their ability to bake products with multiple separate components. Thus, there is a need for device to provide two separate volumes within the bakeware.

### SUMMARY OF THE INVENTION

One embodiment of the invention relates to a cup insert for a bakeware. The cup insert defining two volumes within the bakeware such that a user may, for example, utilize two different types of batter.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a perspective view of a bakeware insert.

FIG. 2 is a top view of a bakeware insert.

FIG. 3 is a side view of a bakeware insert.

FIG. 4 is a side view of a bakeware insert.

FIG. 5 is an end view of a bakeware insert.

FIG. 6 is an end view of a bakeware insert.

FIG. 7 is a bottom view of a bakeware insert.

FIG. 8 is a cross-section along the longitudinal axis of a bakeware insert.

FIG. 9 illustrates a bakeware insert positioned in a bakeware.

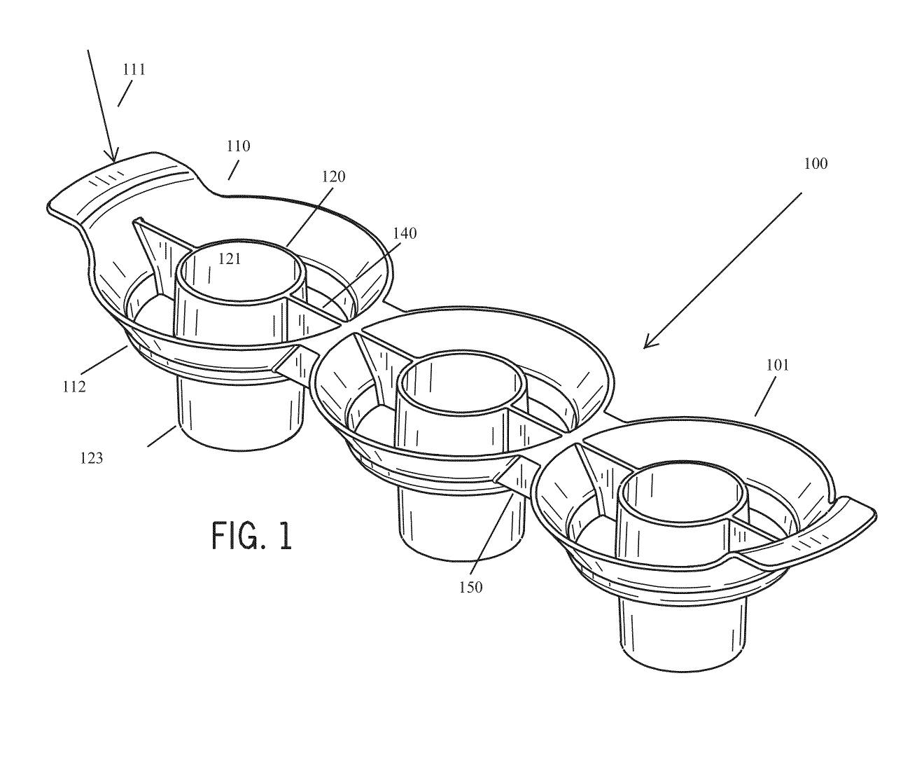

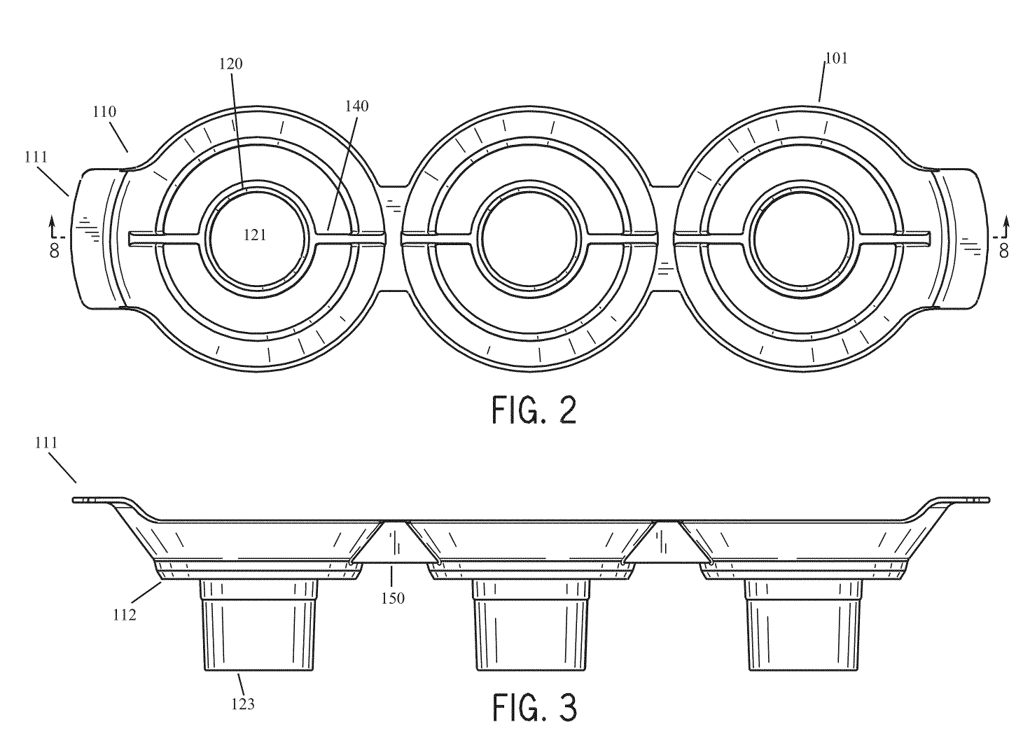

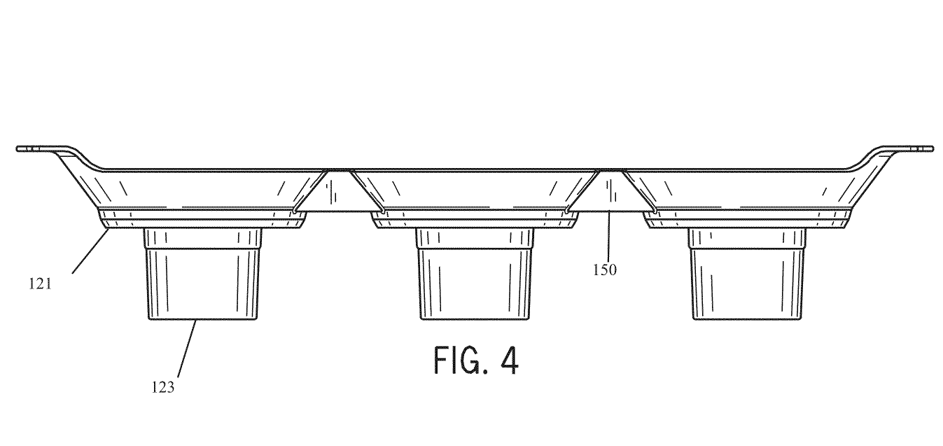

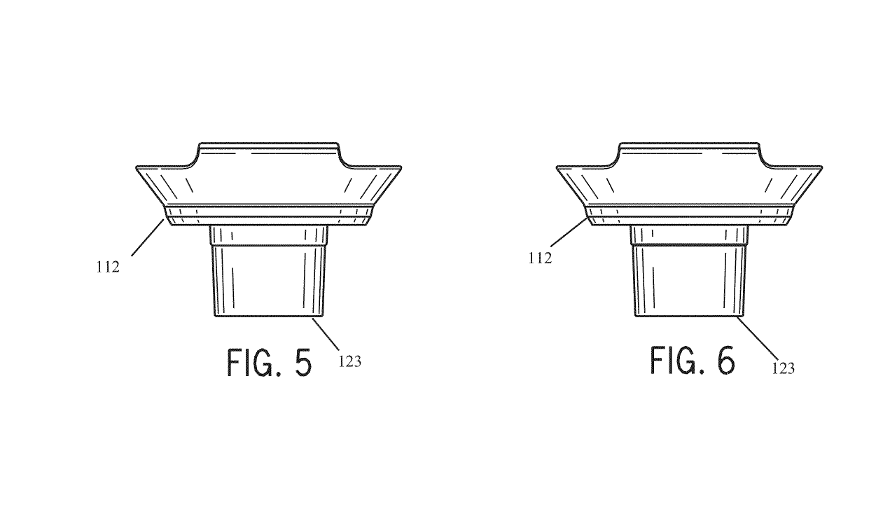

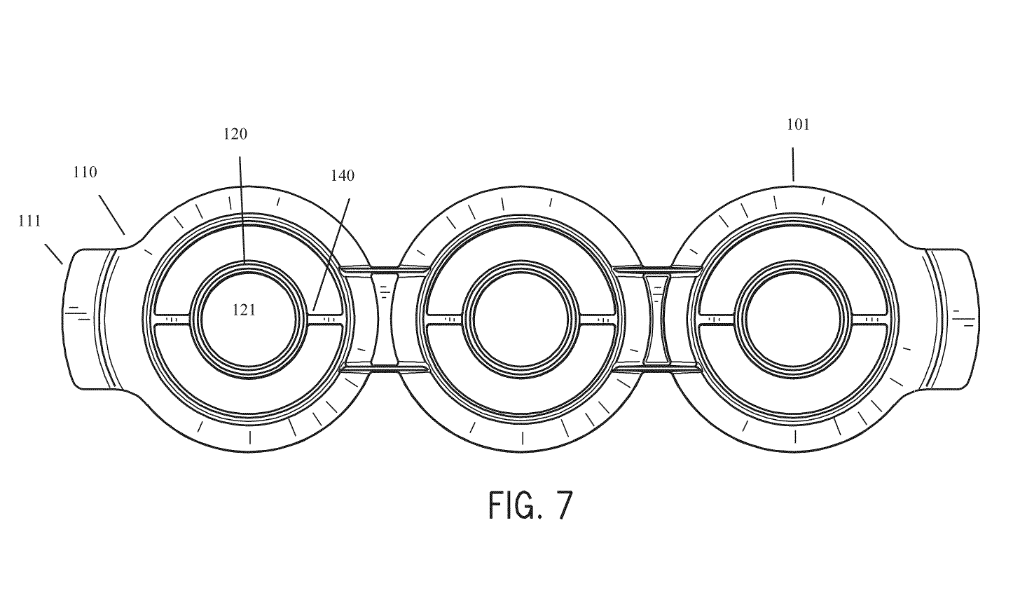

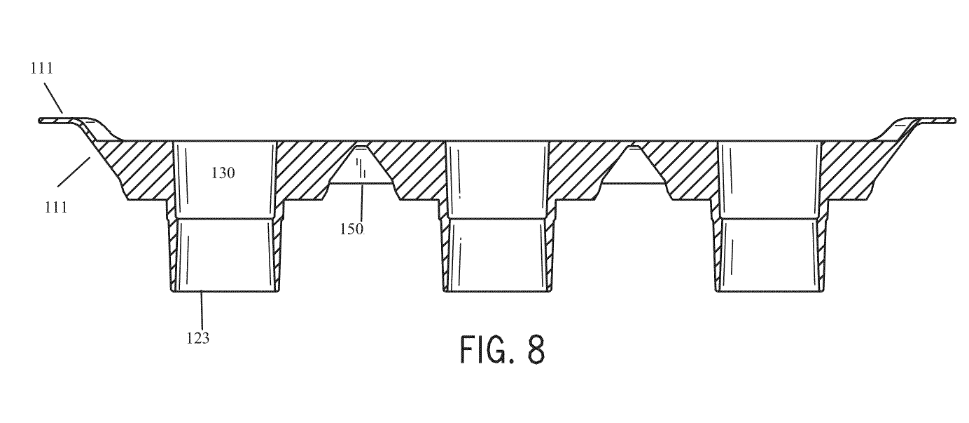

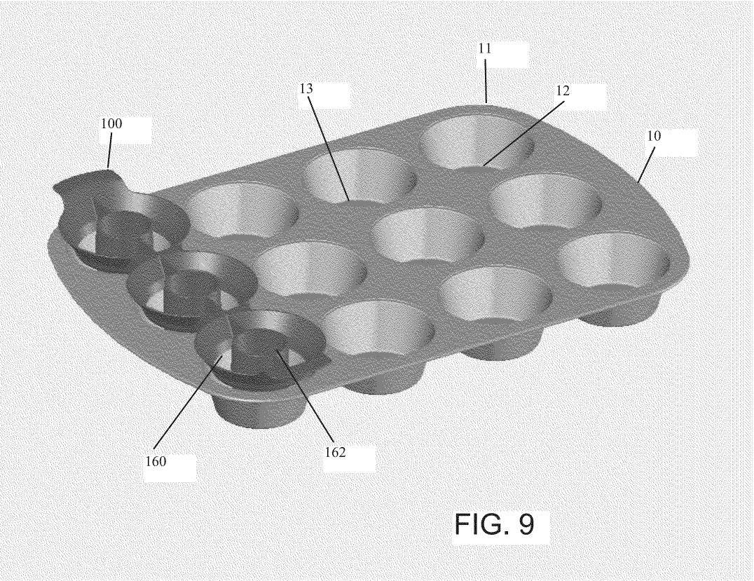

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

A bakeware 10 insert is provided in one implementation for use with a bakeware 10 having one or cups 11. The bakeware insert 100 includes one or more cup inserts 101 comprising a cup insert body 110 and a separator 120. In one implementation, the separator 120 is disposed partially within the cup insert body 110 such that an upper portion of the separator 120 is circumscribed by the cup insert body 110. The outer diameter of the separator 120 is less than the inner diameter of the cup insert body 110.

The cup insert body 110 includes a portion that is wider than the opening to the cup 11. For example, in one embodiment the cup insert body 110 has the shape of an inverted conical frustum, such that the bottom of the cup insert body 110 has a smaller circumference than the top of the cup insert body 110. The cup insert body may be shaped to accommodate insertion or placement with cups 11 of various diameters.

A method of using the bakeware insert 100 comprises placing the bakeware insert 100 on or inserting it into a bakeware 10, such as a cupcake tray. Each cup insert body 110 is aligned with a cup 11 of the bakeware 10. An outer cavity 160 is defined by the sidewalls 12 of the cup 11 at the outer perimeter and the separator 120 at the inner perimeter. An inner cavity 162 is defined within the separator 120. A user may insert a first batter into the interior cavity 162 and a second batter into the outer cavity 160. The bakeware insert 100 may be removed from the bakeware 10. Preferably, the removal does not substantially disturb either the first batter or the second batter or result in substantial mixing of the first batter and second batter. It should be appreciated that the viscosity and other physical and chemical properties of the first batter and second batter may influence the degree to which there is intermixing. Thus, the bakeware 10 may be baked with the first batter substantially separated and internal to the second batter.

In one embodiment the separator 120 may define a three-dimensional central chamber 121 corresponding to the inner cavity 162. The central chamber 121 may be of various shapes, such as but not limited to a polygon, cylinder, or cone. In one embodiment the one or more sides of the central chamber 121, as defined by the separator 120, slope inwards from the top of the central chamber 121 to the bottom of the central chamber 121 to facilitate removal of the bakeware insert 100 once batter has been placed in the cup 11.

In one embodiment the separator 120 is affixed to the cup insertion by one or more separator supports 140. The separator supports 140 may extend from the cup insert body 110 to the separator 120. In one embodiment, the cup insert body 110, separator 120 and separator support 140 are one unitary component, such as a single molded or punched component. In an alternative implementation, the separator 120 is removable from the cup insert body 110. The separator support 140 may be affixed to the separator 120 and removably engageable with the cup insert body 110, such as, but not limited to, tab-and-slot, a tongue-and-grove, snap-fit, thread, or the like. Various embodiments of separators, such as those defining a cylinder, a cone, a rectangular prism or a pyramid may be utilized with the same cup insert. A baker may use a desired separator 120 with a selected shape and insert it into the cup insert body 110 to enable the formation of the first batter portion with the desired shape.

In one embodiment, the separator 120 does not have a fixed vertical position with respect to the cup insert body 110. The separator 120 may move vertically relative to the cup insert body 110, such as to accommodate cups 11 of varying depth. In one embodiment, the separator supports 140 may be flexible and elastic to allow the separator 120 to have a non-fixed vertical position.

In one implementation the separator 120 is in contact with the bottom 13 of the cup 11 when the bakeware insert 100 is positioned. The separator 120 includes a seating surface 123 located about the annular bottom edge. The seating surface 123 forms a seal against the cup 11 to retain the material within the separator 120. In one embodiment, the seating surface 123 comprises a sealing material such as a silicone or thermoplastic. In an alternative embodiment, the separator 120 extends from the cup insert body 110 less than the depth of the cup 11 so as to allow a space at the bottom of the cup 11 between the seating edge 123 and the cup 11. In such an embodiment, the baker may place a small amount of batter into the cup 11, which spreads over the surface of the cup 11 forming a bottom layer. The bakeware insert 100 may then be positioned with the seating surface 123 contacting this bottom layer. The effect is to provide an interior batter portion that is not visible from the bottom of the baked good.

In one embodiment, a top layer of batter, of the first batter, the second batter, or a third batter, may be used to top the batters in the cup. Thus, where the second batter is used, the first batter may be entirely contained within the second batter giving rise to a cupcake with no external indication of the presence of the first batter on the interior.

The cup insert body 110 may further include one or more handles 111. The handles 111 are preferable positioned to be above the bakeware 10 when the bakeware insert 100 is in place, allowing a user to grip the handles 111 to remove the bakeware insert 100.

In one embodiment the cup insert body 110 includes a downward projecting flange 112, such as for engaging the cup 11 of the bakeware 10, for example to stabilize against lateral movement.

A plurality of cup inserts 101 may be provided. In one embodiment, three cup inserts 101 are included in the bakeware insert 100 to correspond with the typical three-cup wide bakeware setup. The cup inserts 101 may be connected by a cup insert connector 150. In one embodiment, the cup insert connector 150 may be integral with the cup insert body 110, such as a single molded component.

One embodiment comprises a bakeware 10 and a bakeware insert 100 as a kit.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus for defining two volumes with a bakeware, comprising:
a cup insert having a cup insert body and a separator, the cup insert adapted to engage the bakeware; and
the separator disposed within the cup insert body and extending below the cup insert body.

2. The apparatus of claim 1, wherein the cup insert body includes an inverted conical frustrum shape.

3. The apparatus of claim 4, wherein the cup insert body includes a downwardly projecting flange.

4. The apparatus of claim 1, wherein the separator is removably affixable to the cup insert body.

5. The apparatus of claim 1, further comprising a separator support extending from the cup insert body to the separator.

6. The apparatus of claim 1, the separator support is flexible and elastic such that the separator has a non-fixed vertical position.

7. The apparatus of claim 1, wherein the separator includes a seating surface configured to sealingly engage the bakeware.

8. The apparatus of claim 1, further comprising a cup insert connector and a plurality of the cup inserts, each cup insert connected to another cup insert by a cup insert connector.

9. The apparatus of claim 1, wherein apparatus includes opposing handles.

10. A bakeware device comprising:
a bakeware having a cup;
a cup insert having a cup insert body and a separator, the cup insert adapted to engage the bakeware; and
the separator disposed within the cup insert body and extending below the cup insert body.

11. The bakeware device of claim 10, wherein the downwardly projecting flange of the cup insert body has a top portion that is wider than a bottom portion, the top portion also being wider than the cup of the bakeware.

12. The bakeware device of claim 10 wherein the outer cavity is defined by the sidewalls of the cup of the bakeware at an outer perimeter, by the separator at an inner perimeter, and by the bottom of the cup.

13. The bakeware device of claim 10 wherein the inner cavity is defined by the separator at an outer perimeter and by the bottom of the cup, the inner cavity disposed within the outer cavity.

14. The bakeware device of claim 10, wherein the separator extends from the cup insert body less than the depth of the cup so as to allow a space at the bottom of the cup between the separator and the cup.

15. The bakeware device of claim 10 wherein the cup insert body includes an inverted conical frustrum shape.

16. The bakeware device of claim 15 wherein the cup insert body includes a downwardly projecting flange.

17. The bakeware device of claim 15, wherein the separator is removably affixable to the cup insert body.

18. The bakeware device of claim 15, wherein the separator includes a seating surface configured to sealingly engage the bakeware.

19. The bakeware device of claim 15, further comprising a cup insert connector and a plurality of the cup inserts, each cup insert connected to another cup insert by a cup insert connector.

20. A method for creating a two-part food item, comprising:
inserting a cup insert having a cup insert body and a separator into a bakeware pan cavity;
dispensing a first material into a first volume defined by the cup insert and walls of the pan cavity; and
dispensing a second material into a second volume defined by the cup insert walls of the pan cavity.
